(19) United States
(12) Patent Application Publication
(10) Pub. No.: US 2009/0178607 A1
(43) Pub. Date: Jul. 16, 2009

(54) Whistle structure

(76) Inventor: Hsiu-Hui Wu, Taipei City (TW)

Correspondence Address: BACON & THOMAS, PLLC, 625 SLATERS LANE, FOURTH FLOOR, ALEXANDRIA, VA, 22314-1176, US

(21) Appl. No.: 12/219,954

(22) Filed: Jul. 31, 2008

Related U.S. Application Data
(63) Continuation of application No. 12/007,729, filed on Jan. 15, 2008.

(51) Int. Cl. G10K 5/00

(52) U.S. Cl. 116/137 R

(57) ABSTRACT

A whistle structure including a main body having at least one exhibition face disposed on an easily observable portion of the main body. S.O.S Morse code, characters or stripes are arranged on the exhibition face in an embossed pattern or a recessed pattern or by way of plane print. The S.O.S Morse code serves as an indication of S.O.S whistle sound signal. Therefore, a user can blow the whistle according to the S.O.S Morse code to create clear and distinguishable S.O.S whistle sound signal.

### BACKGROUND OF THE INVENTION

The present invention is related to an improved whistle structure, and more particularly to a whistle structure equipped with simple and clear indication of S.O.S whistle sound signal. A user can easily blow the whistle to create distinguishable effective S.O.S whistle sound signal according to the indication.

A whistle can be easily blown to create a sound. Therefore, whistles have been long since widely applied to various fields such as warning and attention. Moreover, a general whistle is manufactured at low cost and can be easily carried and used. Therefore, a user can always carry a whistle for warning or help in case of emergency.

However, in current society, there are all kinds of complicated sound sources in daily life. A monotonous (or irregular) whistle sound can hardly attract people's attention. Especially, in the case that an accident or a disaster takes place, such as a car falls into a valley or people are buried in the rubbles due to an earthquake, the rescuers will inevitably use whistles for communication. Under such circumstance, it's hard to tell which whistle sound is that from the victim. Therefore, it will be helpful if the whistle sound from the victim is immediately distinguishable from the common whistle sound. Moreover, in an open space or a remote valley, a contracted code of whistle sound serves as a simple measure of communication. This helps in promoting working efficiency. Therefore, it will be helpful to teach a user of a specific usage of the whistle so as to express a specific content of communication. This can more effectively have people's attention and enhance communication efficiency.

### SUMMARY OF THE INVENTION

It is therefore a primary object of the present invention to provide an improved whistle structure equipped with simple and clear indication of S.O.S whistle sound signal. A user can conveniently blow the whistle to create specific and distinguishable S.O.S whistle sound signal according to the indication.

According to the above object, the whistle structure of the present invention includes a main body for airflow to flow therein to create whistle sound. At least one exhibition face is disposed on outer wall face of the main body. At least one S.O.S Morse code is disposed on the exhibition face of the main body as an indication of S.O.S whistle sound signal.

Besides, since the lateral sides of the main body have quite limited area, a user's fingers can hardly stably press and hold the main body. Therefore, certain stripes are disposed on the sidewall faces of the main body to help the user's fingers to more stably press and hold the main body. In addition, in case of emergency, the stripes enable a user to truly judge the direction of the main body.

The present invention can be best understood through the following description and accompanying drawings wherein:

### BRIEF DESCRIPTION OF THE DRAWINGS

FIG. 1 is a perspective view of a preferred embodiment of the whistle structure of the present invention; and

FIG. 2 is a perspective view showing the use of the whistle structure of the present invention.

### DETAILED DESCRIPTION OF THE PREFERRED EMBODIMENTS

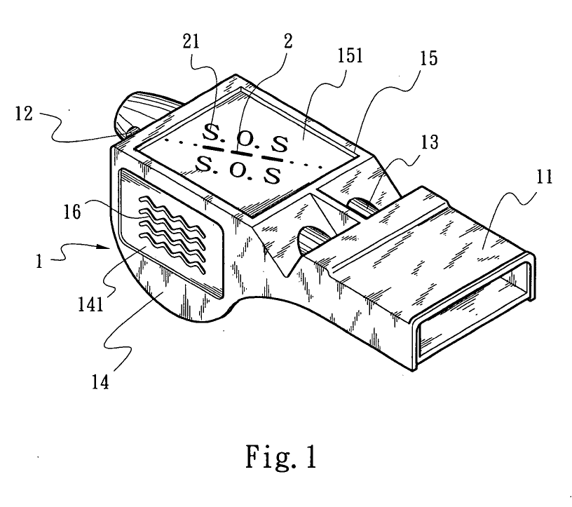

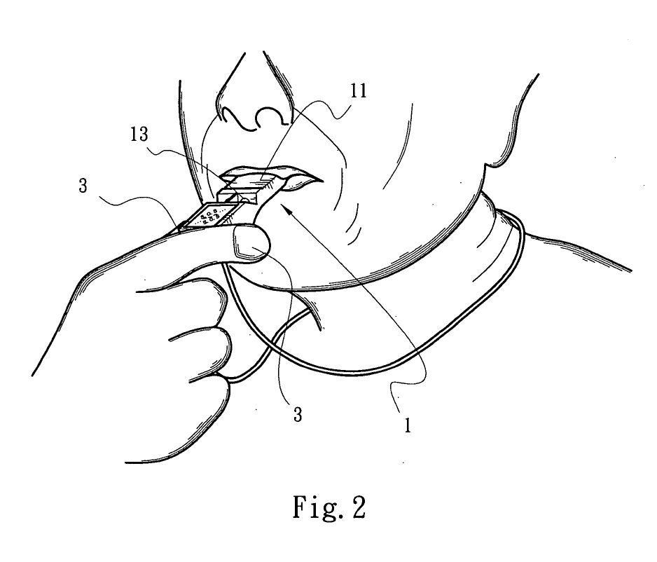

Please refer to FIGS. 1 and 2. The whistle of the present invention includes a main body 1 and an S.O.S Morse code 2 disposed on a surface of the main body 1. In this embodiment, the main body 1 is an elongated tubular body with a substantially rectangular cross-section. In practice, the main body 1 can have an otherwise shaped cross-section or configuration. Two ends of the main body 1 are respectively formed with a nozzle 11 and a tail ring passage 12 for a ring body to pass therethrough, whereby the whistle can be looped to connect with a hanging cord. A middle section of the main body 1 is notched to form at least one nozzle outlet 13. Two sidewall faces 14 are oppositely formed on two lateral sides of the main body 1 for a user's fingers 3 to easily press and hold. A top wall face 15 is formed on a top of the main body 1. An exhibition face 141, 151 with a certain area is arranged on each of the sidewall faces 14 and the top wall face 15 (or any other easily observable part) of the main body 1. In general, the S.O.S Morse code 2 is a traditional three-short, three-long and three-short code. The S.O.S Morse code 2 can be disposed on the exhibition faces 141, 151 by means of different processing methods, for example, etching, pressing, injection molding, embossing, recessing, plane print, etc. In addition, code description characters 21 (such as S.O.S) can be arranged beside the Morse code 2 as necessary. Moreover, as necessary, other characters or figures such as recessed/embossed decorative stripes, wavy stripes 16 (as shown in FIG. 1), a product introduction or a trademark can be arranged on the other sidewall faces 14 or top wall face 15 without the S.O.S Morse code 2.

The exhibition faces 141, 151 are positioned on an easily observable portion of the main body 1 so that a user can easily see the S.O.S Morse code 2. Besides, in the case that the S.O.S Morse code 2 is arranged on the exhibition faces 141,151 in a recessed or an embossed pattern, a visually defective person can be aware of the S.O.S Morse code 2 by touching. Therefore, a user can blow the nozzle 11 according to the indication of the S.O.S Morse code 2. Airflow will pass through and flow out from the nozzle outlet 13 to create a wind shear phenomenon. At this time, a whistle sound corresponding to the S.O.S Morse code 2 is emitted as a clear and effective S.O.S signal.

Furthermore, the recessed/embossed decorative stripes or wavy stripes 16 provide obvious touch feeling and antislip effect. Therefore, a user's fingers can more stably press and hold the main body 1 to take the whistle. In addition, the recessed/embossed decorative stripes provide touch feeling different from other surfaces of the main body 1. With the different touch feeling, a user can easily judge the direction of the main body in emergency or under a condition of poor sight. Therefore, the whistle can be more conveniently used.

According the above arrangement, the whistle structure of the present invention is equipped with simple and clear indication of S.O.S signal so that a user can easily blow the whistle to create distinguishable effective S.O.S whistle sound signal.

The above embodiments are only used to illustrate the present invention, not intended to limit the scope thereof. Many modifications of the above embodiments can be made without departing from the spirit of the present invention.

What is claimed is:

1. A whistle structure comprising:
a main body for airflow to flow therein to create whistle sound, an exhibition face being disposed on at least one outer wall face of the main body; and
an S.O.S Morse code disposed on at least one exhibition face of the main body as an indication of S.O.S whistle sound signal.

2. The whistle structure as claimed in claim 1, wherein the exhibition face is positioned on a sidewall face of a lateral side of the main body.

3. The whistle structure as claimed in claim 1, wherein the exhibition face is positioned on a top wall face of a top of the main body.

4. The whistle structure as claimed in claim 1, wherein description characters of S.O.S. are additionally arranged beside the S.O.S. Morse code.

5. The whistle structure as claimed in claim 2, wherein description characters of S.O.S. are additionally arranged beside the S.O.S. Morse code.

6. The whistle structure as claimed in claim 3, wherein description characters of S.O.S. are additionally arranged beside the S.O.S. Morse code.

7. The whistle structure as claimed in claim 1, wherein the S.O.S. Morse code is disposed on the exhibition face in a recessed pattern.

8. The whistle structure as claimed in claim 2, wherein the S.O.S. Morse code is disposed on the exhibition face in a recessed pattern.

9. The whistle structure as claimed in claim 3, wherein the S.O.S. Morse code is disposed on the exhibition face in a recessed pattern.

10. The whistle structure as claimed in claim 4, wherein the S.O.S. Morse code is disposed on the exhibition face in a recessed pattern.

11. The whistle structure as claimed in claim 1, wherein the S.O.S. Morse code is disposed on the exhibition face in an embossed pattern.

12. The whistle structure as claimed in claim 2, wherein the S.O.S. Morse code is disposed on the exhibition face in an embossed pattern.

13. The whistle structure as claimed in claim 3, wherein the S.O.S. Morse code is disposed on the exhibition face in an embossed pattern.

14. The whistle structure as claimed in claim 4, wherein the S.O.S. Morse code is disposed on the exhibition face in an embossed pattern.

15. The whistle structure as claimed in claim 1, wherein the S.O.S. Morse code is disposed on the exhibition face by way of plane print.

16. The whistle structure as claimed in claim 2, wherein the S.O.S. Morse code is disposed on the exhibition face by way of plane print.

17. The whistle structure as claimed in claim 3, wherein the S.O.S. Morse code is disposed on the exhibition face by way of plane print.

18. The whistle structure as claimed in claim 4, wherein the S.O.S. Morse code is disposed on the exhibition face by way of plane print.

19. The whistle structure as claimed in claim 1, wherein on the exhibition face are disposed recessed, embossed or plane characters/figures.

20. The whistle structure as claimed in claim 2, wherein on the exhibition face are disposed recessed, embossed or plane characters/figures.

21. The whistle structure as claimed in claim 3, wherein on the exhibition face are disposed recessed, embossed or plane characters/figures.

22. The whistle structure as claimed in claim 4, wherein on the exhibition face are disposed recessed, embossed or plane characters/figures.

23. The whistle structure as claimed in claim 19, wherein the characters/figures are recessed/embossed decorative stripes.

24. The whistle structure as claimed in claim 20, wherein the characters/figures are recessed/embossed decorative stripes.

25. The whistle structure as claimed in claim 21, wherein the characters/figures are recessed/embossed decorative stripes.

26. The whistle structure as claimed in claim 22, wherein the characters/figures are recessed/embossed decorative stripes.

27. The whistle structure as claimed in claim 19, wherein the characters/figures are wavy stripes.

28. The whistle structure as claimed in claim 20, wherein the characters/figures are wavy stripes.

29. The whistle structure as claimed in claim 21, wherein the characters/figures are wavy stripes.

30. The whistle structure as claimed in claim 22, wherein the characters/figures are wavy stripes.
